(19) United States
(12) Patent Application Publication
(10) Pub. No.: US 2002/0085849 A1
(43) Pub. Date: Jul. 4, 2002

(54) Image forming apparatus

(76) Inventor: Saijiro Endo, Odawara-shi (JP)

Correspondence Address: FITZPATRICK CELLA HARPER & SCINTO, 30 ROCKEFELLER PLAZA, NEW YORK, NY, 10112, US

(21) Appl. No.: 09/563,323

(22) Filed: May 3, 2000

(30) Foreign Application Priority Data
May 10, 1999 (JP) 11-128281
Apr. 26, 2000 (JP) 2000-125412

(51) Int. Cl. G03G 15/00

(52) U.S. Cl. 399/49

(57) ABSTRACT

Present invention relates to an image forming apparatus comprising a movable body, image forming means for forming on the movable body a toner image which is transferred onto a recording material, fixing means for fixing the toner image on the recording material and detecting means for detecting the toner image for detection formed on the movable body by the image forming means. The detecting means detects the toner image for detection at substantially the farthest location from the fixing means on a peripheral surface of the movable body.

### BACKGROUND OF THE INVENTION

1. Field of the invention

This invention relates to an image forming apparatus utilizing an electrophotographic method, for example, such an image forming apparatus as a copying machine, a printer, a facsimile or the like.

2. Description of the related art

In conventional color image forming apparatuses such as copying machines, printers or the like, an intermediate transfer method where toner images formed in a plurality of image forming sections are sequentially superimposed once on a intermediate transfer body and then transferred onto a recording medium altogether is utilized.

An example of an embodiment of an image forming apparatus utilizing this intermediate transfer method will be explained using FIG. 6. First, electrostatic latent images are formed on a plurality of photographic photosensitive drums 101a, 101b, 101c, and 101d by using light, magnet, electric charge or the like, and then respective toners having respective colors are provided from respective developers 102a, 102b, 102c, 102d to form toner images, thereby visualizing the electrostatic latent images.

An intermediate transfer belt 103 as an intermediate transfer body is arranged to be suspended by a drive roller 105, a driven roller 106 and a tension roller 107 so as to be disposed opposite to all of the photosensitive drums 101a, 101b, 101c, and 101d straightly horizontalized, and the toner images formed on the surfaces of the photosensitive drums 101a, 101b, 101c, and 101d are sequentially transferred onto the intermediate transfer belt 103 to be superimposed by the action of primary transfer blades 104a, 104b, 104c and 104d, as primary transfer means, disposed opposite through the intermediate transfer belt 103 to the respective photosensitive drums 101a, 101b, 101c, and 101d.

In a position opposite, through the intermediate transfer belt 103, to the driven roller 106, disposed is a secondary transfer roller 108 as a secondary transfer means, and sheets P composed of papers, synthetic resins or the like serving as recording mediums are suitably fed from sheet cassettes 109a, 109b, or a manual tray 110 to a position between the intermediate transfer belt 103 and the secondary transfer roller 108 where the toner images transferred on the intermediate transfer belt 103 are re-transferred on the sheets P by the action of the secondary transfer roller 108.

The sheets P on which the toner images have been transferred are subjected to permanent fixation through heating and pressurizing treatments by a fixing device 111, and then delivered out of the apparatus. Using the photosensitive drums 101a, 101b, 101c and 101d as image forming means of Yellow, Magenta, Cyan and Black in a sequential order can give full color images; or using any one of the photosensitive drum 101a, 101b, 101c, or 101d can give unicolored images.

The image forming apparatus with the above-mentioned intermediate transfer method is so structured that the toner images transferred from the photosensitive drums 101a, 101b, 101c and 101d as intermediate transfer bodies onto the intermediate transfer belt 103 are read by using an image reading means 112, and that based on the read image information, image quality improvement is promoted.

The image reading means 112, for instance, reads image density of the toner image formed on the intermediate transfer belt 103, and then based on the information thus obtained, image forming conditions or primary transfer conditions are changed; or output image positions by respective photosensitive drums 101a, 101b, 101c and 101d are detected based on the positions of the toner images formed on the intermediate transfer belt 103, and then, in order to correct the amount of slippage with respect to the position accuracy, the image forming timing or the image forming positions to the photosensitive drums 101a, 101b, 101c and 101d are thereby corrected.

In the aforementioned conventional example, however, the fixing device 111 where the toner image on the sheet P is heated, melted and fixed on the sheet P heats up its surrounding temperature because the fixing device 111 is required to generate quite a huge amount of heat in consideration of its role. The heat thus generated from the fixing device 111 thermally affects various parts arranged around the device, but especially in the case where the heat reaches the intermediate transfer belt 103, thermal expansion is generated in its vicinity of the fixing device 111, and as the belt goes away from the fixing device 111, thermal contraction is generated, and the rotation of the intermediate transfer belt 103 makes this phenomenon repeating.

Accompanied by the heat stretching and contraction of the intermediate transfer belt 103 as mentioned above, the toner images for detection on the intermediate transfer belt 103 become stretched and contracted, and especially in the case where toner images with a plurality of colors are superimposed on the intermediate transfer belt 103, color slippage problem in terms of position arises.

Also, the heat capacity of the intermediate transfer belt 103 becomes smaller because of its structural reason, so the influences by aforementioned heat stretching and contraction are noticeably easy to appear, and consequently there is posed a problem that lowering of the image quality, such as color slippage or the like, easily occurs.

In addition, a problem arises where, when the heat of the intermediate transfer belt 111 affects the image reading means 112, this causes optical parts such as optical lenses constituting the image reading means 112 to generate thermal expansion or distortion, thereby lowering the image reading accuracy.

Furthermore, when the toner images for detection are detected on a peripheral surface of the intermediate transfer belt 103 winding around a roller which supports and suspends the intermediate transfer belt 103, the fixing heat causes the change of roller diameter, resulting in lowering the detecting accuracy.

The same problems as mentioned above occur in image forming apparatuses utilizing conveyance belts for carrying and conveying recording materials in order to sequentially transfer toner images from respective photosensitive drums onto the recording materials.

### SUMMARY OF THE INVENTION

It is an object of the present invention to provide an image forming apparatus capable of improving a detecting accuracy of a detecting means which detects toner images for detection formed on a movable body.

Other objects of the present invention will be apparent by reading the following detail descriptions.

### BRIEF DESCRIPTION OF THE DRAWINGS

The above and other objects and features of the invention are apparent to those skilled in the art from the following referred embodiments thereof when considered in conjunction with the accompanied drawings, in which:

FIG. 1 is a cross-sectional view showing a structure of a first embodiment of an image forming apparatus according to the present invention;

FIG. 2 is an illustration explaining correction of color slippage of four-color toner images;

FIG. 3 is a cross-sectional view showing a structure of a second embodiment of the image forming apparatus according to the present invention;

FIG. 4 is a cross-sectional view showing a structure of a third embodiment of the image forming apparatus according to the present invention;

FIG. 5 is a cross-sectional view showing a structure of a fourth embodiment of the image forming apparatus according to the present invention; and

FIG. 6 is an illustration explaining a conventional example.

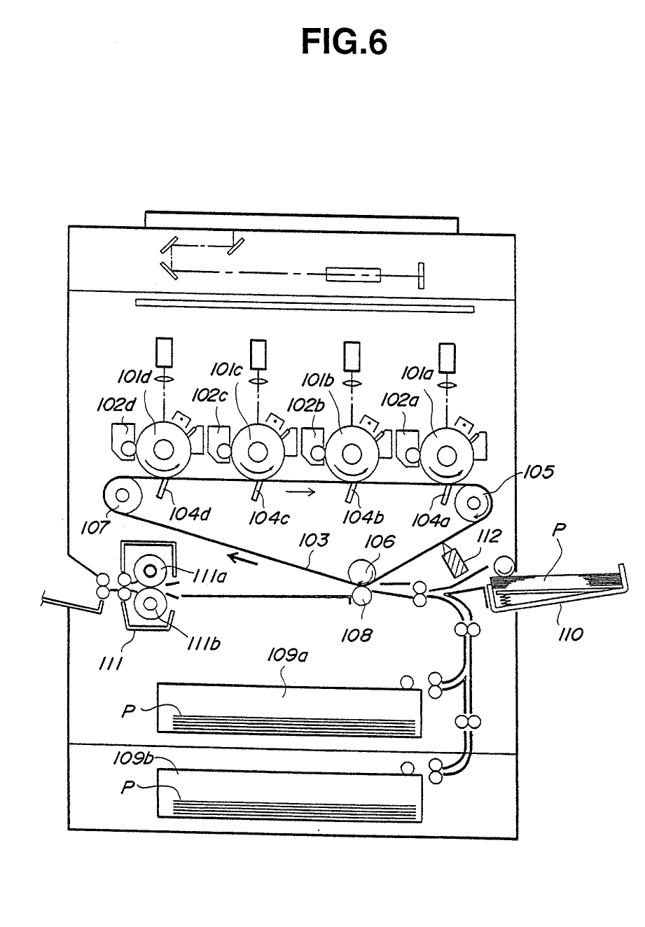

### DETAILED DESCRIPTION OF THE PREFERRED EMBODIMENTS

(First embodiment)

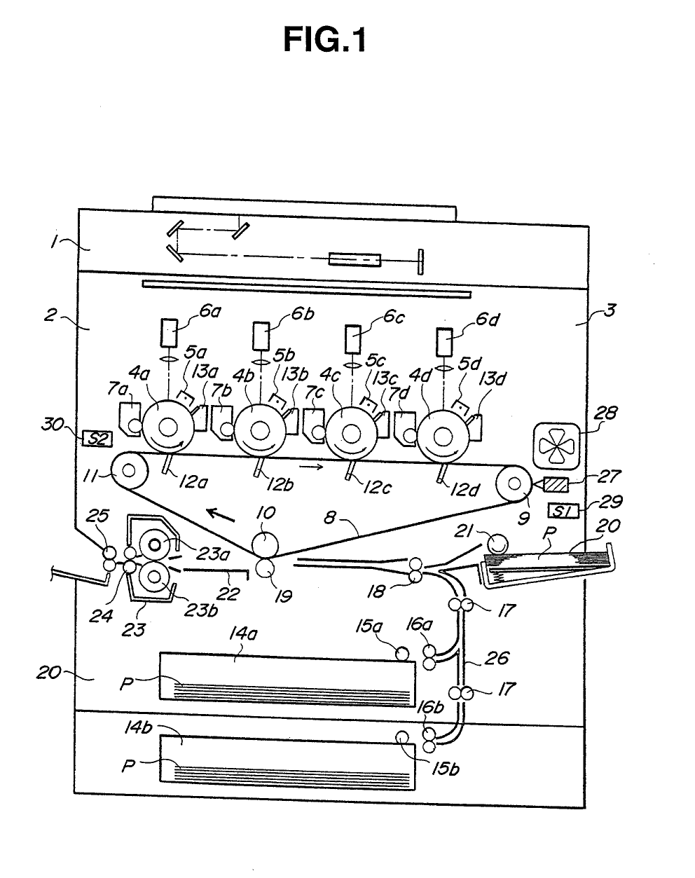

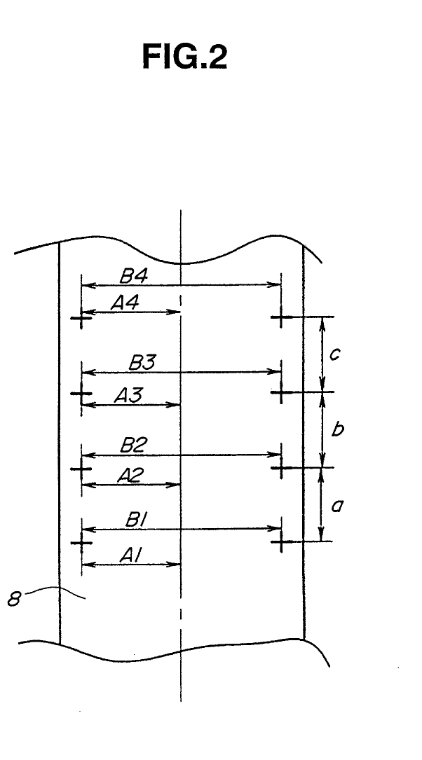

One embodiment of the image forming apparatus according to the present invention when applied to a full color copying machine utilizing the electrophotographic method will be described in detail with reference to the drawings. FIG. 1 is a cross-sectional view showing a structure of a first embodiment of an image forming apparatus according to the present invention, and FIG. 2 is an illustration explaining correction of color slippage of four-color toner images.

First, a structure of the first embodiment of the image forming apparatus according to the present invention will be described by referring to FIG. 1 and FIG. 2. In FIG. 1, numeral 1 refers to an original document image reading apparatus for reading original document images, and numeral 2 refers to an image forming apparatus for forming images on sheets P constituted of papers, synthetic resins or the like based on original document image information read by the original document image reading apparatus 1.

In the upper portion of the image forming apparatus 2, there is arranged an image output section 3 for outputting images in four colors, Yellow, Cyan, Magenta, and Black in such an order as starting from the left side in FIG. 1, and electrophotographic photosensitive drums 4d, 4c, 4b and 4a as image carriers are pivotally supported so as to be able to rotate on their centers in arrow directions in FIG. 1.

On the outer surfaces of the photosensitive drums 4d, 4c, 4b and 4a, primary chargers 5d, 5c, 5b, and 5a; optical systems 6d, 6c, 6b and 6a; and developing devices 7d, 7c, 7b, and 7a are respectively positioned in an order starting from an upstream side of the rotating direction of the photosensitive drums 4d, 4c, 4b, and 4a.

First, electric charges having a uniform amount for electrification are applied to the surfaces of the photosensitive drums 4d, 4c, 4b, and 4a by the primary chargers 5d, 5c, 5b, and 5a, thus to make the surfaces charged, and then by using the optical systems 6d, 6c, 6b and 6a, radiations such as laser beams or the like modulated according to the image signals read by the original document image reading apparatus 1 are exposed onto the photosensitive drums 4d, 4c, 4b, and 4a, thereby forming electrostatic latent images.

Furthermore, developing devices 7d, 7c, 7b, and 7a respectively containing toners serving as respective developing agents of such four colors as Yellow, Cyan, Magenta, and Black positioned in the order starting from the left side in FIG. 1 provide the aforementioned electrostatic latent images with toners in each color as mentioned above to form toner images for making them to be visualized.

On the other hand, an intermediate transfer belt 8 constituted of a belt-form member serving as an intermediate transfer body is suspended by rotatable driving roller 9, driven roller 10 and tension roller 11 so as to be opposite to all of the photosensitive drums 4d, 4c, 4b, and 4a which are straightly horizontalized, and the toner images formed on the surfaces of the photosensitive drums 4d, 4c, 4b and 4a are primarily transferred sequentially for being superimposed on the intermediate transfer belt 8 by applying voltage to primary transfer blades 12d, 12c, 12b and 12a serving as primary transfer means arranged opposite to the respective photosensitive drums 4d, 4c, 4b, and 4a through the intermediate transfer belt 8.

In a downstream side, in the rotating direction of the photosensitive drums 4d, 4c, 4b, and 4a, of respective primary transfer positions on the circumferences of the respective photosensitive drums 4d, 4c, 4b, and 4a, to which the primary transfer blades 12d, 12c, 12b, and 12a are opposite, arranged are cleaning devices 13d, 13c, 13b and 13a where residual toners on the photosensitive drums 4d, 4c, 4b, and 4a without being transferred onto the intermediate transfer belt 8 are scraped off, thereby conducting cleaning of the surfaces of the photosensitive drums 4d, 4c, 4b and 4a.

According to the above-mentioned process, the image forming performances by respective toners onto the photosensitive drums 4d, 4c, 4b and 4a are sequentially conducted.

On the other hand, sheet cassettes 14a and 14b for containing sheets P constituted of such recording materials as papers, synthetic resins or the like are provided in the lower portion of the image forming apparatus 2, and the sheets P contained in the sheet cassettes 14a and 14b are brought up by a pick-up rollers 15a and 15b, and then separated and fed sheet by sheet by retard separation roller pairs 16a, 16b, and further conveyed to a registration roller pair 18 by conveying roller pairs 17.

The sheet P where its skew has been corrected by the registration roller pair 18 is in synchronization with the rotation of the intermediate transfer belt 8, thus to be conveyed between the intermediate transfer belt 8 and a secondary roller 19 serving as a secondary transfer means arranged in a secondary transfer position opposing, through the intermediate transfer belt 8, to the driven roller 10, and then by applying voltage to the secondary transfer roller 19, the toner images having been transferred on the intermediate transfer belt 8 are secondarily transferred onto the sheet P.

Alternatively, the sheet P brought up by the pick-up roller 21 from a manual tray 20 is, after its skew is corrected by the registration roller pair 18, conveyed between the intermediate transfer belt 8 and the secondary transfer roller 19, and by applying voltage to the secondary transfer roller 19, the toner images having been transferred on the intermediate transfer belt 8 are secondarily transferred onto the sheet P.

The intermediate transfer belt 8 is constituted of resin, for example, such as PET (polyethylene terephthalate), PVDF (poly vinylidene fluoride) or the like, and suspended so as to wind the driving roller 9 for transferring rotationally driving force to the intermediate transfer belt 8, the tension roller 11 for providing appropriate tension to the intermediate transfer belt 8 by urging force of a spring (not shown), and the driven roller 10 opposing to the secondary transfer roller 19 through the intermediate transfer belt 8.

Between the driving roller 9 and the tension roller 11 for suspending the intermediate transfer belt 8, a primary transfer flat surface is formed opposing to which the photosensitive drums 4d, 4c, 4b and 4a are straightly arranged. The driving roller 9 is formed to be coated with a rubber layer having a few of millimeters on the surface of the metal roller, and consequentially the slippage between the driving roller and the intermediate transfer belt 8 can be prevented.

In addition, the driving roller 9 is rotationally driven by a pulse motor (not shown). At the primary transfer positions to which respective photosensitive drums 4d, 4c, 4b, and 4a as well as the intermediate transfer belt 8 are opposed, the primary transfer blades 12d, 12c, 12b, and 12a serving as the primary transfer means are provided on the backside of the intermediate transfer belt 8.

The driven roller 10, made as a metal roller formed by using metal, is disposed opposite to the secondary transfer roller 19 serving as the second transfer means, and the driven roller forms the secondary transfer position by the nip portion with the intermediate transfer belt 8. Similarly, the tension roller 11 is made as a metal roller. The secondary roller 19 is pressurized by appropriate pressure with respect to the intermediate transfer belt 8.

The sheet P to which the toner images formed on the intermediate transfer belt 8 have been transferred by the secondary transfer roller 19 is guided by a sheet guide 22 to be conveyed to a fixing device 23 serving as a fixing means, by which the toner images are permanently fixed by heating and pressurizing processes, and then the sheet P is conveyed by an internal delivering roller pair 24 and an external delivering roller pair 25 to be delivered out of the apparatus.

The fixing device 23 has, in its inside, a fixing roller 23a storing a heat source such as a halogen heater or the like, and a pressurizing roller 23b for being pressurized by the fixing roller 23a, and the sheet P led by the sheet guide 22 is subjected to heating and pressurizing processes at the nip portion of the fixing roller 23a with the pressurizing roller 23b, resulting in that the toner images are permanently fixed. It is noted that the pressurizing roller 23b may have a structure storing the heat sources.

Also, a controlling unit 100 serving as a controlling means is provided inside the image forming apparatus 2, and structured to have a controlling base board for controlling the operations of the respective mechanisms of the original document image reading apparatus 1 and the image forming apparatus 2, a motor drive base board for controlling the motor which drives the respective mechanisms, or the like.

Next, the operations of the image forming apparatus 2 with the above-mentioned structure will be described. When an image forming operation signal is issued, the pick-up roller 15a, 15b 21 are selectively driven in a rotational way to bring up the sheets P from the sheet cassettes 14, 14b or the manual tray 20, and the retard separation roller pair 16a, 16b or a separation means not shown feeds out the sheets P piece by piece.

Then, the sheet P is conveyed by the conveying roller pair 17 and then introduced or the like by a sheet guide 26 to be conveyed to the registration roller pair 18. At this time, the rotation of the registration roller pair 18 stops, and the front end of the sheet P hits the nip portion of the registration roller pair 18, but is further fed by the conveying roller pair 17 or the pick-up roller 21, thus to form a loop shape in the sheet, and consequently the skew is corrected, with the elasticity of the sheet P, so as to make the front end of the sheet P to be adjusted along with the nip portion of the registration roller pair 18.

Thereafter, the registration roller pair 18 starts rotating in accordance with timing at which the image forming section including the photosensitive drums 4d, 4c, 4b, and 4a, intermediate transfer belt 8, or the like starts forming images. As for this rotation period of time, the timing is set so that both the toner images primarily transferred onto the intermediate transfer belt 8 from the photosensitive drums 4d, 4c, 4b, and 4a, and the sheet P fit in the secondary transfer position of the nip portion consisting of the intermediate transfer belt 8 and the secondary transfer roller 19.

In the image forming section, on the other hand, when an image forming operation starting signal is issued, according to the above-mentioned process, the toner image formed on the photosensitive drum 4d positioned in the most upstream side (left side in FIG. 1), in the rotating direction of the intermediate transfer belt 8 is primarily transferred, by the high-voltage applied primary transfer blade 12d serving as a primary transfer means, onto the intermediate transfer belt 8 at the primary transfer position where the photosensitive drum 4d and the primary transfer blade 12d oppose each other through the intermediate transfer belt 8.

The primarily transferred toner image is then conveyed to the next primary transfer position at which the photosensitive drum 4c and the primary transfer blade 12c oppose each other through the intermediate transfer belt 8, where image forming process is conducted by retarding only the time required for conveying the toner image between each of the image forming sections. Registration is adjusted on the transferred toner image, and the next toner image is then transferred onto it. The same steps are sequentially repeated hereinafter, and consequently a toner image having four colors formed on the surfaces of respective photosensitive drum 4d, 4c, 4b, and 4a is formed in a superimposed manner on the intermediate transfer belt 8.

Then, the sheet P enters into the nip portion consisting of the intermediate transfer belt 8 and the secondary transfer roller 19, and when the sheet P contacts on the intermediate transfer belt 8, high voltage, in accordance with the passing timing of the sheet P, is applied to the secondary transfer roller 19.

According to the aforementioned process, the toner image with the four colors formed on the intermediate transfer belt 8 is transferred on the surface of the sheet P. Then, the sheet P is accurately led by the sheet guide 22 to the nip portion of the fixing roller 23a with the pressurizing roller 23b.

The toner image is permanently fixed on the surface of the sheet P due to the heat of the fixing roller 23a and the pressurizing roller 23b as well as due to the pressure of the nip portion. The sheet P is thereafter conveyed by the internal delivering roller pair 24 and the external delivering roller pair 25 to be delivered out of the apparatus.

Using the photosensitive drums 4d, 4c, 4b and 4a as image forming means of Yellow, Magenta, Cyan and Black in a sequential order can give full color images; or using any one of the photosensitive drum 4d, 4c, 4b or 4a give unicolored images.

In the present embodiment, as shown in FIG. 1, the fixing device 23 as a heat generating source is provided between the driven roller 10 and the tension roller 11 near the lower portion of the intermediate transfer belt 8.

On the intermediate transfer belt 8 suspended by the outer peripheral surface of the driving roller 9 arranged on approximately the farthest location from the fixing device 23, an image reading means 27 for reading the toner image transferred onto the intermediate transfer belt 8 is provided.

As mentioned above, the image reading means 27 is disposed opposite to the roller 9 through the intermediate transfer belt 8, and consequently the detecting accuracy can be improved without up-and-down fluctuation of the belt, when compared with the conventional structure which has no opposing member.

In the vicinities of the image reading means 27 and the tension roller 11, temperature sensors 29 and 30 serving as temperature measuring means for measuring the internal temperature of the apparatus body are provided, and it is so structured that the controlling apparatus 100 serving as a correcting means corrects, based on the temperature information measured by the temperature sensors 29 and 30, the image information of the toner image transferred onto the intermediate transfer belt 8 read by the image reading means 27.

Also, in the present embodiment, the image reading means 27 doubles the parts of an image position detecting means for detecting the relative positions of the respective color toner images for detection transferred onto the intermediate transfer belt 8 and an image density detecting means for detecting the density of the respective color toner images.

Next, correcting the positional color slippage of the four-color toner images transferred from the photosensitive drums 4d, 4c, 4b, and 4a onto the intermediate transfer belt 8 will be explained with reference to FIG. 2. First, respective color toner images for detection formed on the surfaces of the photosensitive drums 4d, 4c, 4b and 4a are transferred onto the intermediate transfer belt 8.

It is so controlled that the respective toner images formed on the intermediate transfer belt 8 are estranged from each other in a predetermined distance for being written in. For example, in the FIG. 2, the toner images for detection written by the way of transfer on the intermediate transfer belt 8 are shown as cross-mark images, and the positions of the toner images are read by reading these cross-mark images on the intermediate transfer belt 8 with the image reading means 27 utilizing such as CCD (charge-coupled device) or the like.

As shown in FIG. 2, for example, the estranged distances a, b, and c between the respective color toner images on the intermediate transfer belt 8 are read, and these distances should be naturally matched with the predetermined distances which have been controlled at the time of forming the toner images for detection.

But in reality, the positions often slip subtly due to the increased temperature of the inside of the apparatus body, the deformation of, or the mechanical breakdown of the apparatus body, or the like. When the images are superimposed in four colors on the intermediate transfer belt 8 without correcting the amount of the slippage, this causes the color slippage which thus appears on the image.

In order to reduce such color slippage, the image reading means 27 detects the slippage amount of the respective color toner images on the intermediate transfer belt 8 as mentioned above, and according to the slippage amount, the timing of writing images (exposure starting timing) to the photosensitive drums 4d, 4c, 4b and 4a, or the position of writing images to the photosensitive drums 4d, 4c, 4b and 4a is corrected, and as a result, the toner image where the color slippage between four colors has been corrected can be formed on the intermediate transfer belt 8.

The toner image slippage to be corrected includes, in addition to the estranged distance a, b, or c between the respective color toner images for detection in the moving direction (arrow direction) of the intermediate transfer belt 8 shown in FIG. 8, positional slippage amount A1, A2, A3, or A4, magnification B1, B2, B3, or B4, inclination or the like in a direction perpendicular to the moving direction of the intermediate transfer belt 8 (a direction from one edge of the belt to the other edge) as shown in FIG. 2, and each of those above can be similarly corrected.

As mentioned above, the image reading means 27 is disposed so as to read the toner images for detection on the intermediate transfer belt 8, but the detecting position is disposed on the farthest position from the fixing device 23 on the peripheral surface of the intermediate transfer belt 8; in other words, the detecting position is disposed so as to read the toner images for detection on the peripheral surface of the intermediate transfer belt 8 supported by the driving roller 9.

Thus, the detecting position is disposed in a place where the least influence of the toner splash generated by entering of the sheet P with unfixed toner images into the nip portion of the fixing roller 23a with the pressurizing roller 23b is given, as well as disposed in a position where the least thermal influence from the fixing device 23 is given.

Also, a cooling fan 28 may be provided for cooling the image reading portion (image reading means 27) as shown in the drawing in order to read, in a state of further eliminating the thermal influence by the fixing device 23, the toner images for detection at the image reading portion by the image reading means 27 on the intermediate transfer belt 8.

When the cooling fan 28 is employed as a cooling means, the splashing toner generated at the nip portion of the fixing roller 23a with the pressurizing roller 23b is to be blown by wind pressure at around the image reading portion by the image reading means 27, and consequently the image reading portion by the image reading means 27 is not affected by stains.

In addition, since the driving roller 9 for rotationally driving the intermediate transfer belt 8 is located at the farthest position from the fixing device 23, the driving roller 9 has not barely been affected by the thermal influence from the fixing device 23, and as a result, changing in the diameter of the driving roller 9 by the heat expansion is not produced, thereby capable of improving the detecting accuracy, and furthermore, the intermediate transfer belt 8 can conduct stable rotational driving without fluctuation of its rotational driving speed.

The intermediate transfer belt 8 has small heat capacity due to its structural reason, thereby easily affected by the thermal influence of the fixing device 23; however, at the image reading portion by the image reading means 27, the driving roller 9 having larger heat capacity than that of the driven roller 10 or the tension roller 11 contacts the backside of the intermediate transfer belt 8 to absorb the heat of the intermediate transfer belt 8, and therefore, the thermal influence on the intermediate transfer belt 8 can be minimized.

In the vicinity of the fixing device 23, the intermediate transfer belt 8 is heated by the heat generated by the fixing device 23, and as it goes sequentially from the photosensitive drums 4d, to 4c, to 4b and to 4a, the temperature influence on the belt becomes less, and then the belt is cooled to stay in a most stable state in the vicinity of the driving roller 9 disposed in a position the farthest from the fixing device 23.

Consequently, the intermediate transfer belt 8 composed of such material as rubber, resin or the like is in the most heat-expanded state in the vicinity of the fixing device 23; on the other hand, it is in the most heat-contracted state in the vicinity of the driving roller 9.

Because the image reading means 27 for reading the position of the toner image for detection on the intermediate transfer belt 8 to correct the image forming timing of the respective colors to the respective photosensitive drums 4d, 4c, 4b and 4d is disposed in the vicinity of the driving roller 9, the image reading position read in the portion is a position where the intermediate transfer belt 8 is in the most heat-contracted state, and therefore, there is a case where the position slippage is produced between the aforementioned image reading position and the toner image position at the image forming position by the photosensitive drums 4d, 4c, 4b, and 4a having the respective colors.

In order to prevent the color slippage generated by the heat expansion accompanied by such temperature change, the sensors 29 and 20 measure the temperature distribution (the temperature distribution in the moving direction of the intermediate transfer belt) inside the apparatus body; and from the results, stretching and contraction change by the heat of the intermediate transfer belt 8 is conjectured; and from the information, the image information of the toner image read by the image reading means 27 is corrected by the controlling device 100, and the amount of the color slippage is further reduced, and therefore, high quality images can be obtained.

Also, the image reading means 27 may detect, in addition to the toner image position on the intermediate transfer belt 8, the toner image density on the sheet P.

According to the above-mentioned structure, the image reading means 27 is disposed in approximately the farthest position from the fixing device 23 on the intermediate transfer belt 8 for reading the toner image for detection, and this can minimize the influence to cause the image reading means 27 to be stained by the toner splashing in the vicinity of the fixing device 23, and can further minimize the influence by heat generated at the fixing device 23.

In addition, the image reading portion by the image reading means 27 on the intermediate transfer belt 8 is cooled down by using the cooling fan 28, and this can further suppress the influence by the heat.

In the case that a temperature sensor for measuring the internal temperature of the apparatus body is provided, preferably at least two in different positions in the moving direction of the intermediate transfer belt, and that an image correcting means for correcting image information read by the image reading means 27 based on the temperature information measured by the temperature sensor or temperature sensors is provided, errors produced in the image information which is read by the image reading means 27 due to the difference in the temperature distribution inside the apparatus body are corrected by the image correcting means, making it possible to read images with a high degree of accuracy.

(Second embodiment)

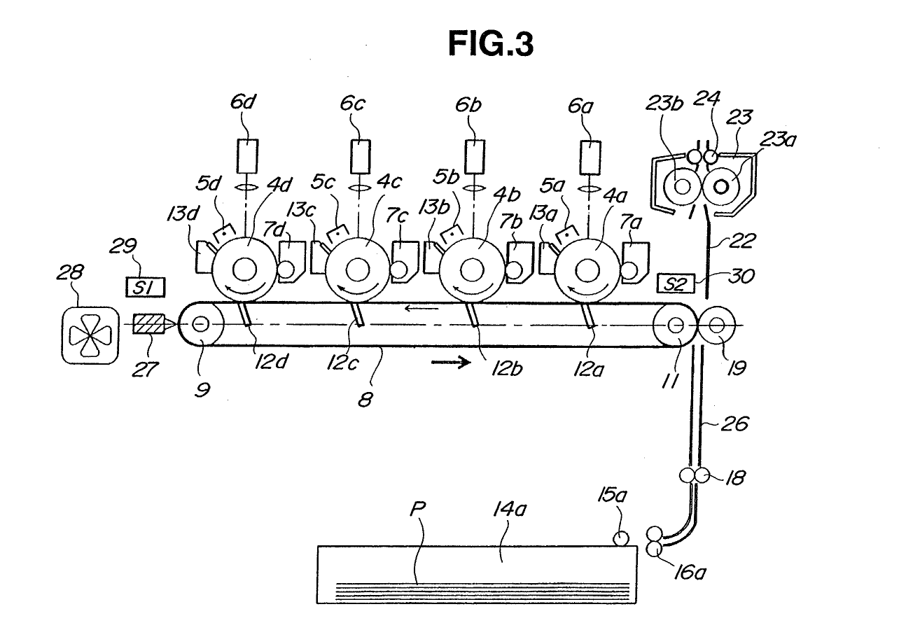

Next, a second embodiment of the image forming apparatus according to the present invention will be described with reference to FIG. 3. FIG. 3 is a cross-sectional view showing a structure of the second embodiment of the image forming apparatus according to the present invention. It is noted that the descriptions of the elements same as those used in the first embodiment are omitted by giving the identical numerals.

In this embodiment, as shown in FIG. 3, an intermediate transfer belt 8 constituted of a belt-form member serving as an intermediate transfer body is suspended by rotatable driving roller 9, driven roller 10 and tension roller 11 so as to be opposite to all of photosensitive drums 4d, 4c, 4b, and 4a which are straightly horizontalized.

In a position opposite to the tension roller 11 through the intermediate transfer belt 8, provided is a secondary transfer roller 19 serving as a secondary means, and as the same in the first embodiment, sheets P contained in a sheet cassette 14a are brought up by a pick-up roller 15a and then separated and fed sheet by sheet by retard separation roller pair 16a, and further conveyed to a registration roller pair 18 by which the skew of the sheet is corrected. Then, the sheet P is led by a sheet guide 26 to be conveyed in a vertically upward direction between the intermediate transfer belt 8 and the secondary transfer roller 19, and by operation of the secondary transfer roller 19, the toner images having been transferred on the intermediate transfer belt 8 are secondarily transferred onto the sheet P.

The sheet P to which the toner images formed on the intermediate transfer belt 8 have been secondarily transferred by the operation of the secondary transfer roller 19 is guided by a sheet guide 22 to be conveyed to a fixing device 23 serving as a fixing means, by which the toner images are permanently fixed by heating and pressurizing processes, and then the sheet P is conveyed by an internal delivering roller pair 24 and an external delivering roller pair 25 (not shown) to be delivered out of the apparatus.

In the present embodiment, as shown in FIG. 3, the fixing device 23 as a heat generating source is provided above the tension roller 11 wound with the intermediate transfer belt 8.

On the peripheral surface of the intermediate transfer belt 8 suspended by the outer peripheral surface of the driving roller 9 arranged on approximately the farthest location from the fixing device 23, an image reading means 27 for reading the toner images for detection transferred onto the intermediate transfer belt 8 is provided, and in the vicinity of the image reading means 27, a cooling fan 28 serving as a cooling means for cooling an image reading portion by the image reading means 27 on the intermediate transfer belt 8 is provided.

In the vicinities of the image reading means 27 and the tension roller 11, temperature sensors 29 and 30 serving as temperature measuring means for measuring the internal temperature of the apparatus body are provided, and it is so structured that a correcting means corrects, based on the temperature information measured by the temperature sensors 29 and 30, the image information of the toner image transferred onto the intermediate transfer belt 8 read by the image reading means 27.

In the above structure, the sheet P is fed sheet by sheet from the sheet cassette 14a to the pick-up roller 15a and the retard separation roller pair 16a, and then conveyed by the registration roller pair 18 to a secondary transfer position made of a nip portion of the intermediate transfer belt 8 with the secondary transfer roller 19.

Similarly in the first embodiment, after formed on the surfaces of the photosensitive drums 4d, 4c, 4b and 4a having the respective colors, the toner images are primarily transferred onto the intermediate transfer belt 8 by primary transfer blades 12d, 12c, 12b and 12a serving as primary transfer means. The intermediate transfer belt 8 is conveyed in an arrow direction in FIG. 3, and the toner images on the intermediate transfer belt 8 are re-transferred onto the sheet P by using the secondary transfer roller 19 as a secondary transfer means.

The sheet P where the toner images have been re-transferred is heated and pressurized by passing through the fixing device 23, and then, the toner images are permanently fixed thus to be delivered out of the apparatus.

The image reading portion by the image reading means 27 for detecting the toner images for detection on the intermediate transfer belt 8 is disposed in the farthest position from the fixing device 23 as a heat generating source on the intermediate transfer belt 8, so this can minimize the influence of toner splashing generated at the nip portion of the fixing roller 23a with the pressurizing roller 23b in the fixing device 23 to the image reading portion by the image reading means 27 on the intermediate transfer belt 8.

It is especially effective because the toner splashing amount generated at the nip portion of the fixing roller 23a with the pressurizing roller 23b in the fixing device 23 become larger since the conveying direction includes a component of the vertically upward direction according to the present embodiment as shown in FIG. 3.

In addition, since the driving roller 9 for rotationally driving the intermediate transfer belt 8 is located at the farthest position from the fixing device 23, the thermal influence to the intermediate transfer belt 8 can be minimized. Also, changing in the diameter of the driving roller 9 by the heat stretching and contraction is not produced because the temperature change in the driving roller 9 on itself is small, and therefore, the rotational driving speed of the intermediate transfer belt 8 can be stabilized.

Other configurations are structured in the same way as in the first embodiment as mentioned above.

(Third embodiment)

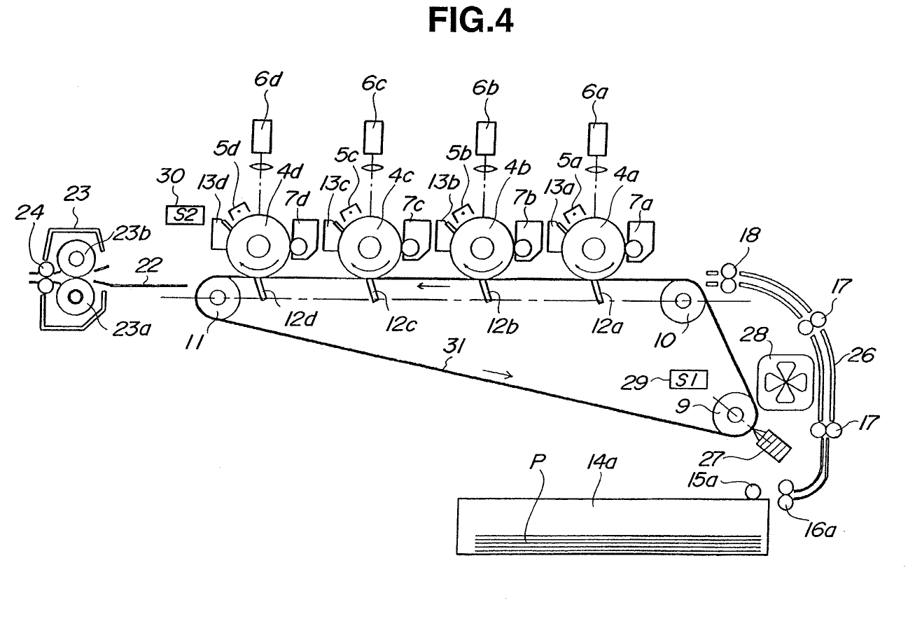

Next, a third embodiment of the image forming apparatus according to the present invention will be described with reference to FIG. 4. FIG. 4 is a cross-sectional view showing a structure of a third embodiment of the image forming apparatus according to the present invention. It is noted that the descriptions of the elements same as those used in the respective previous embodiments are omitted by giving the identical numerals.

The respective aforementioned embodiments have a structure where toner images formed on the photosensitive drums 4d, 4c, 4b, and 4a are once transferred onto the intermediate transfer belt 8 and the transferred toner images on the intermediate transfer belt 8 are further re-transferred onto a sheet P; on the other hand, the present embodiment has a structure where toner images formed on the photosensitive drums 4d, 4c, 4b and 4a serving as image carriers are transferred onto a sheet P serving as a recording material carried and conveyed by a conveying belt 31 constituted of a belt form member serving as a recording material carrier, and it can apply the present invention in the same way as in the aforementioned embodiments.

As shown in FIG. 4, the conveying belt 31 for carrying and conveying the sheet P to the position where the toner images formed on the photosensitive drums 4d, 4c, 4b, and 4a are transferred is suspended by rotatable driving roller 9, driven roller 10 and tension roller 11 so as to be opposite to all of the photosensitive drums 4d, 4c, 4b, and 4a which are straightly horizontalized.

Also, the fixing device 23 as a heat generating source is disposed on a place extending from the conveying belt to which all of the photosensitive drums 4d, 4c, 4b and 4a oppose. The conveying belt 31 can be composed of approximately the same resin as that used in the intermediate transfer belt 8 in the respective above-mentioned embodiments.

On the conveying belt 31 suspended by the outer peripheral surface of the driving roller 9 arranged on approximately the farthest location from the fixing device 23, an image reading means 27 for reading the toner images for detection transferred from the photosensitive drums 4d, 4c, 4b and 4a onto the conveying belt 31 is provided, and in the vicinity of the image reading means 27, a cooling fan 28 serving as a cooling means for cooling an image reading portion by the image reading means 27 on the conveying belt 31 is provided.

In the vicinities of the image reading means 27 and the tension roller 11, temperature sensors 29 and 30 serving as temperature measuring means for measuring the internal temperature of the apparatus body are provided, and it is so structured that a correcting means corrects, based on the temperature information measured by the temperature sensors 29 and 30, the image information of the toner images of detection transferred onto the intermediate transfer belt 8 read by the image reading means 27.

In order to form images on the sheets P, the sheets P, brought up from a cassette 14a by a pick-up roller 15a and separated and fed sheet by sheet by a retard separation roller pair 16a, are then conveyed by a conveying roller pair 17 to reach, led by a sheet guide 26, a registration roller pair 18 by which the skew of the sheet is corrected, and then the sheet P is conveyed on the conveying belt 31.

The sheet P placed on the conveying belt 31 passes through, in a state of being carried on the conveying belt 31 by electrostatic attracting force, sequentially under the photosensitive drums 4d, 4c, 4b and 4a having the respective colors. On the other hand, the toner images are formed, as the same way in the aforementioned first embodiment, on the surfaces of the photosensitive drums 4d, 4c, 4b and 4a having the respective colors, and when the sheet P is sequentially conveyed to pass through positions to which the respective photosensitive drums 4d, 4c, 4b and 4a oppose, the toner images from the photosensitive drums 4d, 4c, 4b and 4a having the respective colors are sequentially superimposed by transfer blades 12d, 12c, 12b and 12a serving as transferring and charging means for being electrostatically transferred onto the sheet P placed on the conveying belt 31.

The sheet P where the toner images having the respective colors are sequentially superimposed is led by a sheet guide 22 to be conveyed to a fixing device 23 serving as a fixing means, by which the toner images are permanently fixed by heating and pressurizing processes, and then the sheet P is conveyed by an internal delivering roller pair 24 and an external delivering roller pair 25 (not shown) to be delivered out of the apparatus.

On the other hand, the toner images for detection are formed from the photosensitive drums 4d, 4c, 4b and 4a onto the conveying belt 31 at a predetermined timing other than that for operation to form the images on the sheet P, and these toner images are read by the image reading means 27 in the same way as in the aforementioned first embodiment.

The image reading portion by the image reading means 27 on the conveying belt 31 is disposed in the farthest position from the fixing device 23 as a heat generating source on the conveying belt 31, so this can minimize the influence of toner splashing generated at a nip portion of a fixing roller 23a with a pressurizing roller 23b in the fixing device 23 to the image reading portion by the image reading means 27 on the conveying belt 31.

In addition, since the driving roller 9 for rotationally driving the conveying belt 31 is located at the farthest position from the fixing device 23, the thermal influence to the conveying belt 31 can be minimized. Also, changing in the diameter of the driving roller 9 by the heat stretching and contraction is not produced because the temperature change in the driving roller 9 on itself is small, and therefore, the rotational driving speed of the conveying belt 31 can be stabilized.

After read by the image reading means 27, the toner images transferred onto the conveying belt 31 are suitably cleaned by a cleaning means (not shown). Other configurations are structured in the approximately same way as in the above-mentioned embodiments, and the same advantage as those in the above-mentioned embodiments can be obtained.

(Fourth embodiment)

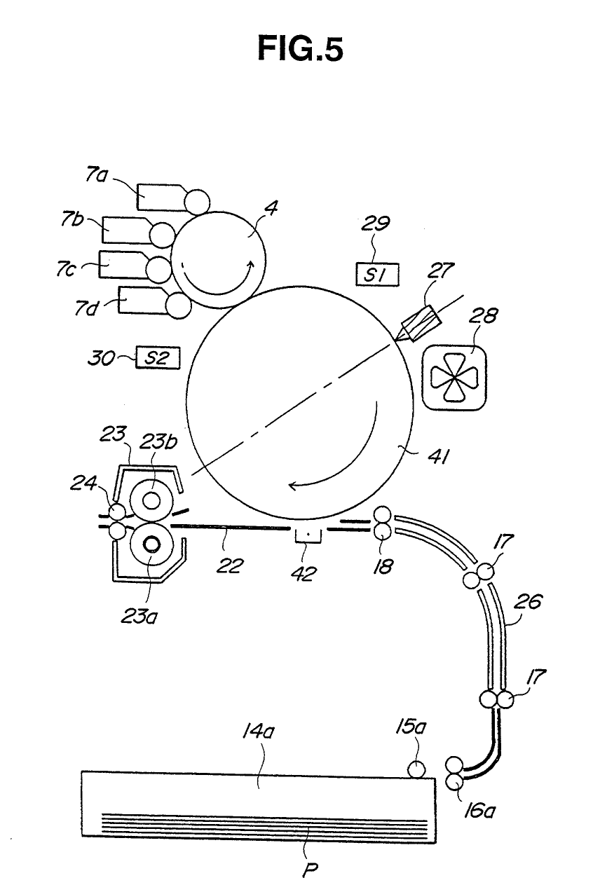

Next, a fourth embodiment of the image forming apparatus according to the present invention will be described with reference to FIG. 5. FIG. 5 is a cross-sectional view showing a structure of a fourth embodiment of the image forming apparatus according to the present invention. It is noted that the descriptions of the elements same as those used in the respective previous embodiments are omitted by giving the identical numerals.

In the present embodiment as shown in FIG. 5, single electrophotographic photosensitive drum 4 serving as a image carrier to form toner images is provided, and on the outer surface of the photosensitive drum 4, sequentially provided are developing devices, each of which contains a toner having different one color from the four colors, Yellow, Magenta, Cyan and Black.

On the outer surface of the photosensitive drum 4, a primary charger 5, an optical system 6 and a cleaning means 13 are disposed in approximately the same way as in the first embodiment as mentioned above. Also, an intermediate transfer drum 41 is rotatably disposed opposite to the photosensitive drum 4, the intermediate transfer drum 41 serving as an intermediate transfer which secondarily transfers, after a toner image formed on the photosensitive drum 4 is primarily transferred, the primarily transferred toner image onto a sheet P.

The photosensitive drum 4 having a uniformly charged surface is exposed by an exposing means 6 to form an electrostatic latent image. After that, the developing device 7a, first, provides toner to develop the toner image, and then, by a transfer means 12 to apply voltage to core metal of the intermediate transfer drum 41, the toner image is primarily transferred onto a surface layer on the core metal of the intermediate transfer drum 41.

Next, an electrostatic latent image is again formed on the photosensitive drum 4, and the developing device 7b forms the second color toner image on the photosensitive drum 4, and then the toner image is superimposed on the intermediate transfer drum 41, thus to be transferred, with a timing used for superimposing on the toner image already formed. In the same way, the successive toner images by the sequential developing devices 7c and 7d, after formed on the photosensitive drum 4, are then superposed on the intermediate transfer drum 41.

In the present embodiment, as shown in FIG. 5, a fixing device 23 serving as a heat generating source is disposed near the lower portion of the intermediate transfer drum 41, and an image reading means 27 is disposed opposite to the fixing device 23 through the intermediate transfer drum 41.

As a result, in approximately the farthest location from the fixing device 23 on the intermediate transfer drum 41, the image reading means 27 for reading the toner images for detection transferred onto the intermediate transfer drum 41 is provided, and in the vicinity of the image reading means 27, a cooling fan 28 serving as a cooling means for cooling an image reading portion by the image reading means 27 on the intermediate transfer drum 41 is provided.

In the vicinities of the image reading means 27 and the fixing device 23, temperature sensors 29 and 30 serving as temperature measuring means for measuring the internal temperature of the apparatus body are provided, and it is so structured that a correcting means corrects, based on the temperature information measured by the temperature sensors 29 and 30, the image information of the toner image for detection transferred onto the intermediate transfer drum 41 read by the image reading means 27.

As the same way in the first embodiment, sheets P, brought up from a cassette 14a by a pick-up roller 15a and separated and fed sheet by sheet by a retard separation roller pair 16a, are then conveyed by a conveying roller pair 17 to reach, led by a sheet guide 26, a registration roller pair 18 by which the skew of the sheet is corrected, and then the sheet P is conveyed, in a timing so as to match with the toner images superimposed on the intermediate transfer drum 41, to a portion between the intermediate transfer drum 41 and a secondary transfer charging device 42, disposed opposite to the intermediate transfer drum 41, serving as a secondary transfer means. The toner images transferred on the intermediate transfer drum 41 are secondarily transferred on the sheet P by the operation of the secondary transfer charging device 42 composed of a charging wire or the like.

The sheet P to which the toner images formed on the intermediate transfer drum 41 have been secondarily transferred by the operation of the secondary transfer charging device 41 is guided by a sheet guide 22 to be conveyed to a fixing device 23 serving as a fixing means, by which the toner images are permanently fixed by heating and pressurizing processes, and then the sheet P is conveyed by an internal delivering roller pair 24 and an external delivering roller pair 25 (not shown) to be delivered out of the apparatus.

The image reading portion by the image reading means 27 on the intermediate transfer drum 41 is disposed in the farthest position from the fixing device 23 as a heat generating source on the intermediate transfer drum 41, so this can minimize the influence of toner splashing generated at a nip portion of a fixing roller 23a with a pressurizing roller 23b in the fixing device 23 to the image reading portion by the image reading means 27 on the intermediate transfer drum 41.

In addition, the cooling fan 28 arranged around the image reading means 27 cools down the image reading means 27, so this can prevent the thermal factor from deteriorating the reading accuracy of the toner images for detection by the image reading means 27.

By arranging the temperature sensors 29 and 30 inside the apparatus body, the shape change of the intermediate transfer drum 41 due to heat is predicted, and based on the prediction value, the image information of the toner images for detection read by the image reading means 27 can be corrected, thus capable of achieving the improvement in the reading accuracy.

Other configurations are structured in the same way as in the first embodiment as mentioned above, and substantially the same advantages can be obtained.

The embodiments according to the present invention were described hereinbefore, but the present invention is not limited to these, and various modifications can be made within the idea of the present invention.

What is claimed is:

1. An image forming apparatus comprising:
a movable body;
image forming means for forming on the movable body a toner image, which is transferred onto a recording material;
fixing means for fixing the toner image on the recording material; and
detecting means for detecting the toner image for detection formed on the movable body by the image forming means,
wherein the detecting means detects the toner image for detection at substantially the farthest location from the fixing means on a peripheral surface of the movable body.

2. The image forming apparatus according to claim 1, comprising controlling means for controlling image forming conditions by the image forming means based on detected results detected by the detecting means.

3. The image forming apparatus according to claim 2, wherein the controlling means controls density of the toner image formed on the movable body.

4. The image forming apparatus according to claim 1, wherein the image forming means has a plurality of image carriers, each of which carries a toner image of one of a plurality of colors, each toner image in each color on each image carrier sequentially being superimposed over one another and transferred onto the movable body.

5. The image forming apparatus according to claim 4, comprising controlling means for controlling timing of forming the toner images on the respective image carriers.

6. The image forming apparatus according to claim 4, further comprising controlling means for controlling densities of respective toner images formed on the respective image carriers.

7. The image forming apparatus according to claim 1, further comprising cooling means for cooling a vicinity of the detecting means.

8. The image forming apparatus according to claim 7, wherein the cooling means has a cooling fan.

9. The image forming apparatus according to claim 1, wherein the detecting means is provided around the substantially farthest location from the fixing means on the peripheral surface of the movable body.

10. An image forming apparatus comprising:
a movable body;
image forming means for forming a toner image on a recording material carried by the movable body;
fixing means for fixing the toner image on the recording material; and
detecting means for detecting the toner image for detection formed on the movable body by the image forming means,
wherein the detecting means detects the toner image for detection at substantially the farthest location from the fixing means on a peripheral surface of the movable body.

11. The image forming apparatus according to claim 10, comprising controlling means for controlling image forming conditions by the image forming means based on detected results detected by the detecting means.

12. The image forming apparatus according to claim 11, wherein the controlling means controls density of the toner image formed on the movable body.

13. The image forming apparatus according to claim 10, wherein the image forming means has a plurality of image carriers, each of which carries a toner image of one of a plurality of colors, each toner image in each color on each image carrier sequentially being superimposed over one another and transferred onto the movable body.

14. The image forming apparatus according to claim 13, comprising controlling means for controlling timing of forming the toner images on the respective image carriers.

15. The image forming apparatus according to claim 13, further comprising controlling means for controlling densities of respective toner images formed on the respective image carriers.

16. The image forming apparatus according to claim 10, further comprising cooling means for cooling a vicinity of the detecting means.

17. The image forming apparatus according to claim 16, wherein the cooling means has a cooling fan.

18. The image forming apparatus according to claim 10, wherein the detecting means is provided around the substantially farthest location from the fixing means on the peripheral surface of the movable body.

19. An image forming apparatus comprising:
a belt body;
a plurality of rollers supporting the belt body;
image forming means for forming on the belt body a toner image, which is transferred onto a recording material;
fixing means for fixing the toner image on the recording material; and
detecting means for detecting the toner image for detection formed on the belt body by the image forming means,
wherein the detecting means detects the toner image for detection at a location on the belt body supported by the roller placed at the farthest location from the fixing means among the plural rollers.

20. The image forming apparatus according to claim 19, comprising controlling means for controlling image forming conditions by the image forming means based on detected results detected by the detecting means.

21. The image forming apparatus according to claim 20, wherein the controlling means controls density of the toner image formed on the belt body.

22. The image forming apparatus according to claim 19, wherein the image forming means has a plurality of image carriers, each of which carries a toner image of one of a plurality of colors, each toner image in each color on each image carrier sequentially being superimposed over one anther and transferred onto the belt body.

23. The image forming apparatus according to claim 22, further comprising controlling means for controlling timing of forming the toner images on the respective image carriers.

24. The image forming apparatus according to claim 22, still further comprising controlling means for controlling densities of respective toner images formed on the respective image carriers.

25. The image forming apparatus according to claim 19, further comprising cooling means for cooling a vicinity of the detecting means.

26. The image forming apparatus according to claim 25, wherein the cooling means has a cooling fan.

27. The image forming apparatus according to claim 19, wherein the detecting means detects the toner image for detection on the belt body supported by a driving roller for rotationally rotating the belt body.

28. The image forming apparatus according to claim 27, wherein the driving roller has a rubber layer on its surface.

29. The image forming apparatus according to claim 19, wherein the detecting means is provided around the location on a peripheral surface of the belt body supported by the roller placed at the farthest location from the fixing means among the plural rollers.

30. An image forming apparatus comprising:
a belt body;
a plurality of rollers supporting the belt body;
image forming means for forming a toner image on a recording material carried by the belt body;
fixing means for fixing the toner image on the recording material; and
detecting means for detecting the toner image for detection formed on the belt body by the image forming means,
wherein the detecting means detects the toner image for detection at a location on the belt body supported by the roller placed at the farthest location from the fixing means among the plural rollers.

31. The image forming apparatus according to claim 30, comprising controlling means for controlling image forming conditions by the image forming means based on detected results detected by the detecting means.

32. The image forming apparatus according to claim 31, wherein the controlling means controls density of the toner image formed on the belt body.

33. The image forming apparatus according to claim 30, wherein the image forming means has a plurality of image carriers, each of which carries a toner image of one of a plurality of colors, each toner image in each color on each image carrier sequentially being superimposed over one another and transferred onto the belt body.

34. The image forming apparatus according to claim 33, further comprising controlling means for controlling timing of forming the toner images on the respective image carriers.

35. The image forming apparatus according to claim 33, still further comprising controlling means for controlling densities of respective toner images formed on the respective image carriers.

36. The image forming apparatus according to claim 30, further comprising cooling means for cooling a vicinity of the detecting means.

37. The image forming apparatus according to claim 36, wherein the cooling means has a cooling fan.

38. The image forming apparatus according to claim 30, wherein the detecting means detects the toner image for detection on the belt body supported by a driving roller for rotationally rotating the belt body.

39. The image forming apparatus according to claim 38, wherein the driving roller has a rubber layer on its surface.

40. The image forming apparatus according to claim 30, wherein the detecting means is provided around the location on a peripheral surface of the belt body supported by the roller placed at the farthest location from the fixing means among the plural rollers.

41. An image forming apparatus comprising:
a movable body;
image forming means for forming a toner image on a movable body or on a recording material carried by the movable body;
detecting means for detecting the toner image for detection formed on the movable body by the image forming means;
temperature detecting means for detecting internal temperature of an apparatus body; and
correcting means for correcting a detected result detected by the detecting means based on a detected result of the temperature detecting means.

42. The image forming apparatus according to claim 41, comprising controlling means for controlling image forming conditions by the image forming means based on the detected results detected by the detecting means.

43. The image forming apparatus according to claim 42, wherein the controlling means controls density of the toner image formed on the movable body.

44. The image forming apparatus according to claim 41, wherein the image forming means has a plurality of image carriers, each of which carries a toner image of one of a plurality of colors, each toner image in each color on each image carrier sequentially being superimposed over one another and transferred onto the movable body or the recording material carried by the movable body.

45. The image forming apparatus according to claim 44, comprising controlling means for controlling timing of forming the toner images on the respective image carriers.

46. The image forming apparatus according to claim 44, further comprising controlling means for controlling densities of respective toner images formed on the respective image carriers.

47. The image forming apparatus according to claim 41 or claim 44, wherein the toner image formed on the movable body is transferred onto the recording material.

48. The image forming apparatus according to claim 41, further comprising cooling means for cooling a vicinity of the detecting means.

49. The image forming apparatus according to claim 48, wherein the cooling means has a cooling fan.

50. The image forming apparatus according to claim 41,
wherein a plurality of the temperature detecting means are provided, and
wherein the correcting means corrects the detected results by the detecting means based on a plurality of the detected results by the plural temperature detecting means.

51. The image forming apparatus according to claim 50, wherein the plural temperature detecting means are provided at different locations in a moving direction of the movable body.
